(19) United States
(12) Patent Application Publication
(10) Pub. No.: US 2015/0013621 A1
(43) Pub. Date: Jan. 15, 2015

(54) COMBINED DOG TRAINING COLLAR AND LEASH

(71) Applicants: Paul Kaiser, Weehawken, NJ (US); Beatrice Tavakoli, Weehawken, NJ (US)

(72) Inventors: Paul Kaiser, Weehawken, NJ (US); Beatrice Tavakoli, Weehawken, NJ (US)

(21) Appl. No.: 13/938,456

(22) Filed: Jul. 10, 2013

(51) Int. Cl. A01K 27/00

(52) U.S. Cl. CPC A01K 27/001; A01K 27/003
USPC 119/793

(57) ABSTRACT

A combined training collar leash for walking, training and otherwise providing the ability to restrain the movement of a dog having an elongated leash with a identical, minor image handle mechanisms disposed at each end of the leash and a locking tab which can slide along the length of the leash and over the handle mechanism and lock in place disposed thereon. When the combined training collar leash is in use, one of the handle mechanisms is placed over a dog's head and around the dog's neck, and then the locking tab is slid over the circular collar to reduce where the circumference of the circular collar to fit snug around the dog's neck. The circular collar of the opposing handle mechanism can be grasped by the user to serve as a handle for the combined training collar leash.

### BACKGROUND OF THE INVENTION

1. Field of the Invention

This invention relates generally to pet accessories and, more particularly, to a training collar and leash for a dog which eliminates the need for metal clips with chokers.

2. Description of the Prior Art

Dogs are generally understood to be the first animal domesticated by humans. Often dubbed “Man's best friend” in Western cultures, dogs are well known to perform many roles for people, such as hunting, herding, pulling loads, protection, assisting police and military, companionship, and even aiding the physically challenged.

Dog training as an organized activity can be traced back at least to the 18^{th} century. In present times, a number of particularized dog collars for training activities are commonly used. Two widespread collar types utilized for such activities are slip collars (including choke chains) and prong collars. Slip collars are embodied as an elongated portion having rings at each and are well known to be configured in a manner which allows the strap to be used as a collar which is configured to tighten around a dog's neck whenever tension is placed on a live ring and loosen around the dog's neck whenever tension is removed from the live ring. Slip collars having a metal elongated portion are generally referred to as choke chains.

Prong collars are made of metal interlocking links, each with two blunt prongs or clips that pinch the dog's skin when the collar is tightened. As such, they operate under a similar concept as slip collars, by exerting force around a dog's neck in response to tension in the leash. It is noted, however, that prong collars are often considered to exert such force in a more even and safe manner.

A problem which still exists, however, is that conventional collars are embodied as chokers or include metal clips which can injure a dog's neck or skin or otherwise be dangerous to a dog. Thus, there remains a need for a collar and leash combination which can be used for training and can eliminate the need for chokers or metal clips. It would be helpful for such a collar and leash combination to allow for either end to selectively function as the handle or collar. It would additionally be desirable for such a collar and leash combination to include rotation points which allow it to resist tangling while in use.

The Applicant's invention described herein provides for a combined dog training leash and collar which will not injure a dog's neck or irritate a dog's skin. The primary components of Applicant's combined dog leash and collar are an elongated leash, a collar/handle attached at each end of the leash and a sliding lock. When in operation, the combined dog leash and collar allows a user to secure either end of the structure around a dog's neck for training and other purposes without causing any discomfort to the dog's neck and use the opposing end as a handle. As a result, many of the limitations imposed by conventional training collars and conventional leashes are removed.

### SUMMARY OF THE INVENTION

A combined training collar leash for walking, training and otherwise providing the ability to restrain the movement of a dog comprises an elongated leash having a identical, mirror image handle mechanisms disposed at each end of the leash and a locking tab disposed thereon which can slide along the length of the leash and lock in place. In this manner the leach provides a leash means for tethering a handle apparatus and a collar apparatus. The handle mechanisms each include a circular collar and two rotatably connected “D” rings and independently serve as a first handle means for securing and a second handle means for securing.

When the combined training collar leash is in use, the leash is slid through the circular collar of one of the handle mechanisms and that circular collar is then placed over a dog's head and around the dog's neck. The locking tab is slid over that same circular collar where it overlaps with the leash to securely set the circumference of the circular collar at a desired length to fit snug around the dog's neck. In this manner, the locking tab provides a setting means for fitting. The circular collar of the opposing handle mechanism is then grasped by the user to serve as a handle for the combined training collar leash.

It is an object of this invention to provide a collar and leash combination which can be used for training and can eliminate the need for chokers or metal clips.

It is another object of this invention to provide a collar and leash combination which allows for either end to selectively function as the handle or collar.

It is yet another object of this invention to provide a collar and leash combination which includes rotation points which allow it to resist tangling while in use.

These and other objects will be apparent to one of skill in the art.

### BRIEF DESCRIPTION OF THE DRAWINGS

FIG. 1 is a top plan view of a combined training collar leash built in accordance with the present invention having its sliding lock disengaged.

FIG. 2 is a top plan view of a combined training collar leash built in accordance with the present invention having its sliding lock engaged.

FIG. 3 is a side elevational view of a locking mechanism for a combined training collar leash built in accordance with the present invention.

### DETAILED DESCRIPTION OF THE INVENTION

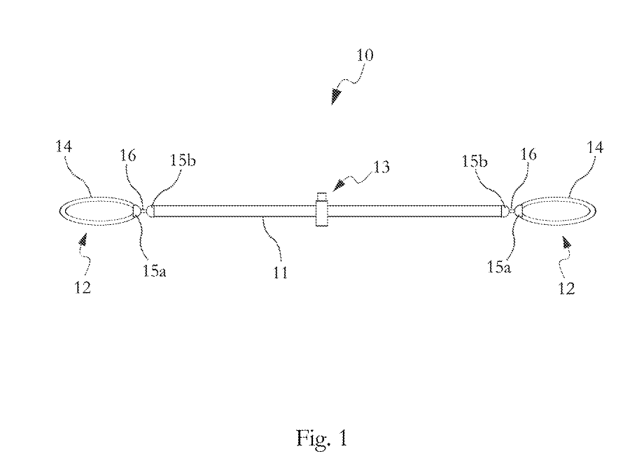

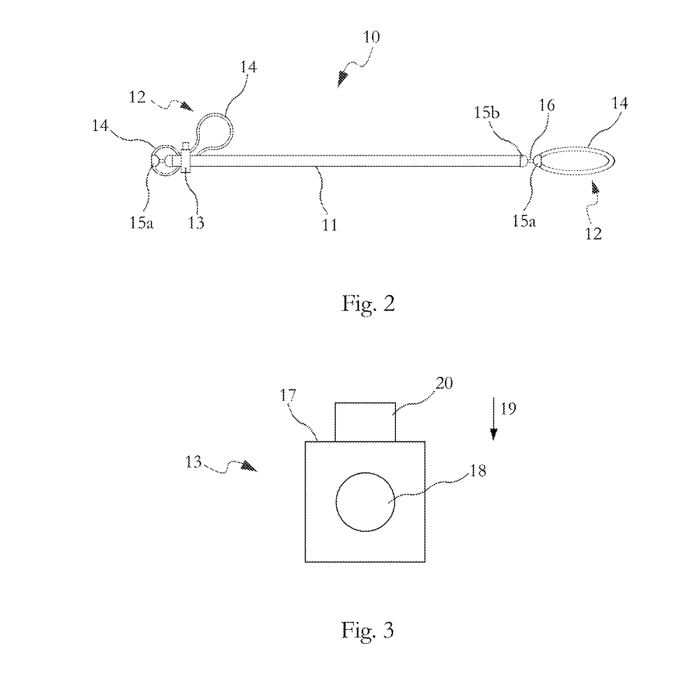

Referring now to the drawings and in particular FIGS. 1 and 2, a combined training collar leash 10 comprises an elongated leash 11 having a first end and a second end, wherein a handle mechanism 12 is disposed at each end of the leash 11. A locking tab 13 is slidably disposed on said leash 11 and can slide along the length of the leash 11 and be selectively positioned and locked. Each handle mechanism 12 is an identical, minor image of the other.

The handle mechanism 12 is defined by a circular collar 14 which passes through a proximal “D” ring 15a and a distal “D” ring 15b which is fastened to the proximal “D” ring by way of a connector bolt 16. The distal “D” ring 15b is securely fixed to the end of the leash 11 and the proximal “D” ring 15a, distal “D” ring 15b, and connector bolt 16 function as a rotating connector portion of the handle mechanism 14. The circular collar 14 functions as the collar portion of the handle mechanism 14 and, in the preferred embodiment, is made of a synthetic woven material.

The connector bolt 16 fastens the proximal “D” ring 15a to the distal “D” ring 15b in a manner that allows each ring to rotate independently about the axis created by the that connector bolt. In the preferred embodiment, the connector bolt 16 attaches to each “D” ring (collectively, 15) in an identical manner, wherein the body of the connector bolt 17 is sized to pass through a ring aperture in the body of the “D” ring 15 and the end of the connector bolt 17 is sized to not fit through said ring aperture so as to hold the connector bolt 17 substantially in place while not being fixed to any surface of the body of the “D” ring 15 so as to allow the “D” ring 15 to rotate about the axis of the point where the connector bolt 16 passes through it.

When not in use, the locking tab 13 can be locked over any portion of the leash 11 as shown in FIG. 1. When the combined training collar leash 10 is in use, the leash 11 is first slid through the circular collar 14, in a manner similar to a slip collar, and the circular collar 14 is placed over a dog's head and around the dog's neck. The locking tab 13 is slid over that same circular collar 14 where it overlaps with the leash 11 to securely set the circumference of the circular collar 14 at a desired length to fit snug around the dog's neck. Because of this, the circular collar 14 can be fitted precisely around the dog's neck so as to avoid injuring the dog while training. The locking tab 13 locked in place over the circular collar 14 is shown in FIG. 2.

Referring now to FIG. 3, in the preferred embodiment, the locking tab 13 is defined by a body member 17 having a body aperture 18 which passes through its body and a clamp (not shown) which is spring biased to close the body aperture or exert pressure on any structure which is passes through the body aperture so as to lock such a structure in its current place. In this manner, when manual force in an unlocking direction 19 is exerted on an actuator 20 of the locking tab 13, the body aperture 18 is opened and structures can freely pass through the body aperture 18. Under such a circumstance, the locking tab 13 can be slid over the leash 11 and over the circular collar 14. When manual force in an unlocking direction 19 is removed, the clamp is closed and the locking tab 13 is locked in place at whatever location on the combined training collar leash 10 that it was in when such force was removed.

Because the gentle but resilient nature of the material comprising the handle mechanisms 12 on each side of the combined training collar leash 10, whichever handle mechanism 12 is not being used around a dog's neck is used as the handle for the combined training collar leash 10. It is also noted that when the combined training collar leash 10 is operated, the rotating nature of the “D” rings 15 allow the user to control the dog's movements in a variety of directions while using such ability to rotate to resist becoming entangled.

In an alternate embodiment of the present invention, locking mechanism 13 utilizes an alternate locking structure. It is contemplated that an alternate locking structure which would sufficiently substitute for the spring loaded clamp would be the type of locking mechanisms know to be utilized with shoe laces or other dual string structures, such as a user actuated ratchet lock system, a bolt lock system, and a user actuate clamp system.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A combined training collar leash comprising:
an elongated leash having a first end and a second end;
a first rotating connector portion connected to the first end;
a second rotating connector portion connected to the second end;
a first collar portion connected to said first rotating connector;
a second collar portion connected to said second rotating connector; and
a locking tab slidably disposed on said combined training collar leash, wherein said locking tab is adapted to selectively lock in place on the elongated leash, the first collar portion, or the second collar portion at a given time.

2. The combined training collar leash of claim 1, wherein said first rotating connector portion and said second rotating connector portion are minor images of one another.

3. The combined training collar leash of claim 1, wherein said first collar connector portion and said second collar connector portion are minor images of one another.

4. The combined training collar leash of claim 1, wherein said first rotating connector portion and said second rotating connector portion are defined by a proximal “D” ring connected to a distal “D” ring by way of a connector bolt.

5. The combined training collar leash of claim 4, wherein the connector body is defined by an elongated body having minor image end points, and the elongated body is sized to pass through a ring aperture in the body of the proximal “D” ring and the distal “D” ring and the end points are sized to not fit through said ring apertures.

6. The combined training collar leash of claim 6, wherein said first collar connector portion and said second collar connector portion each are defined by a circular body of synthetic woven material.

7. The combined training collar leash of claim 1, wherein sliding the locking tab over said first collar portion causes the circumference of the circular body to decrease.

8. The combined training collar leash of claim 7, wherein the locking tab is size to not fit over the first rotating connector portion or the second rotating connector portion.

9. The combined training collar leash of claim 1, wherein the locking tab comprises a tab body having a body aperture and a spring biased clamp which exerts clamping pressure on any structure which passes through the body aperture so as to lock the locking tab in place.

10. The combined training collar leash of claim 9, wherein the application of manual force to the locking tab engages the spring biased clamp in a manner which lessens the clamping pressure exerted by the spring biased clamp.

11. A combined training collar leash comprising:
a leash means for tethering a handle apparatus and a collar apparatus;
a first handle means for securing attached to one end of said leash means;
a second handle means for securing attached to the end of said leash means opposite the first handle means;
a setting means for fitting slidaby disposed on said combined training collar leash.

12. The combined training collar leash of claim 11, wherein said first handle means and said second handle means are mirror images of each other.
